(19) United States
(12) Patent Application Publication
(10) Pub. No.: US 2019/0329994 A1
(43) Pub. Date: Oct. 31, 2019

(54) WHEEL CHOCK WITH MAGNETIC LOCK

(71) Applicant: ICONTROLS INC., Richmond Hill (CA)

(72) Inventor: Gregory ION, Richmond Hill (CA)

(21) Appl. No.: 16/118,765

(22) Filed: Aug. 31, 2018

Related U.S. Application Data
(60) Provisional application No. 62/662,432, filed on Apr. 25, 2018.

(51) Int. Cl. B65G 69/00; B60T 3/00; H01F 7/06

(52) U.S. Cl. CPC B65G 69/005; H01F 2007/062; H01F 7/06; B60T 3/00

(57) ABSTRACT

A wheel chock with a magnet actuated to lock and unlock with an underlying steel plate is anchored to the adjacent pavement. A proximity sensor senses the presence or absence of the underlying steel plate to ensure proper placement and magnetic engagement. Wireless transmission/receiver communications between the wheel chock, magnet, proximity sensor and a loading dock operations console provides remote sensing and control of the locking and unlocking operation. An electro magnet or a manually actuated permanent magnet can be used. The electromagnet can receive electric power from a battery or can be hard wired to the adjacent loading dock. The permanent magnet option may include wireless communication and a battery to be physically independent of the loading dock.

### TECHNICAL FIELD

The invention relates to a wheel chock with a magnet actuated to lock and unlock with an underlying steel plate anchored to the adjacent pavement. A proximity sensor senses the presence or absence of the underlying steel plate to ensure proper placement and magnetic engagement.

### BACKGROUND OF THE ART

The loading and unloading of transport trucks and trailers requires some means to prevent movement of the truck or trailer. The truck or trailer is usually backed into proximity of an elevated loading dock and a dock leveler or bridge is extended between the loading dock platform and truck or trailer bed. The truck and trailer brakes are engaged to prevent the truck or trailer from moving. However brakes can fail or the driver can forget to engage brakes.

As a common safety measure, additional means to prevent movement of the truck or trailer are used. Failure to keep the truck or trailer in position can result in the dock leveler falling and thus creating significant risk of personal injury and equipment damage.

Wheel chocks are also commonly used in association with various wheeled vehicles such as transport trucks and trailers, railroad cars, construction vehicles and aircraft. Movement during maintenance and loading of wheeled vehicles can cause personal injury accidents and property or equipment damage.

Movement of forklift loading vehicles from a loading dock to a truck or trailer bed over a dock leveler causes the truck bed or trailer bed to move vertically due to the passing of loaded forklift since the bed is supported on a load sensitive suspension system with springs, shock absorbers or air cushions. The suspension system of the truck or trailer is compressed and decompressed when loaded and unloaded by the passage of forklift or other vehicles between the stationary loading dock and the moving trailer bed. The action of the suspension can cause the truck or trailer to roll, jump or bounce thus moving the truck or trailer away from the loading dock even when brakes are engaged.

Typically wheel chocks are positioned in front of wheels to prevent movement. Simple chocks may be triangular wooden or rubber blocks, aluminum triangular blocks, or mechanical chock devices. Often flags or projecting signs are used to indicate the presence of chocks and to warn the drivers that chocks are in place so that they do not attempt to load, unload, or drive away before the chocks are installed or removed from engaging the wheels.

Such simple wheel chocks have disadvantages including that a loading dock operator has to visually examine the truck wheel area to confirm the presence of wheel chocks before commencing loading operations, such as opening a loading dock door, actuating the dock leveler, and driving forklift vehicles onto the truck bed or trailer bed. At night or in cold weather, fog or rain, visual confirmation that a wheel chock is properly in place may be difficult. Exiting the building to closely examine the wheel chock placement is inconvenient and may be neglected.

Some mechanical wheel chock systems include sensors and wired or wireless communication to indicate whether a wheel chock is installed. Examples are shown in U.S. Pat. No. 8,286,757, and US Publication 2016/0272168.

Features that distinguish the present invention from the background art will be apparent from review of the disclosure, drawings and description of the invention presented below.

### DISCLOSURE OF THE INVENTION

The invention provides a wheel chock with a magnet actuated to lock and unlock with an underlying steel plate anchored to the pavement beneath the wheels to be chocked. A proximity sensor senses the presence or absence of the underlying steel plate to ensure proper placement and magnetic engagement. Wireless or hard wired power and communications between the wheel chock, magnet, proximity sensor and a loading dock operations console provides remote sensing and control of the wheel chock locking and unlocking operation. The wheel chock may include a rechargeable battery for powering the electromagnet, sensors and communications. A storage bracket for the wheel chock may include a battery recharger. Alternatively the electromagnet, sensors and communications may be electrically powered by an electrical power wire in communication with a source of electric power from the adjacent loading dock or building.

Alternatively, a permanent magnet may be used with a manually operated lever to engage and disengage the permanent magnet with the underlying steel plate. In the case of a permanent magnet, sensors and communications can be electrically powered by a rechargeable battery and can be controlled wirelessly. Therefore a permanent magnet option allows the wheel chock to be separate from and physically independent of the loading dock and building.

### DESCRIPTION OF THE DRAWINGS

In order that the invention may be readily understood, one embodiment of the invention is illustrated by way of example in the accompanying drawings.

FIG. 1 is an elevation view of a conventional prior art semi-transport truck trailer combination against a loading dock with a dock leveler and triangular wheel chock in position.

FIG. 2 is a perspective view of a conventional wheel chock of generally triangular shape made of extruded aluminum.

FIG. 3 is a schematic sectional view of the invention including a wheel chock in place over a steel plate on the pavement adjacent to a wheel, the wheel chock having an electromagnet to engage and disengage the steel plate, and a proximity sensor protected inside the chock housing.

FIG. 4 is an alternative schematic sectional view of the invention including a wheel chock having an permanent magnet operated with a manual lever to engage and disengage the steel plate.

Further details of the invention and its advantages will be apparent from the detailed description included below.

### DETAILED DESCRIPTION OF PREFERRED EMBODIMENTS

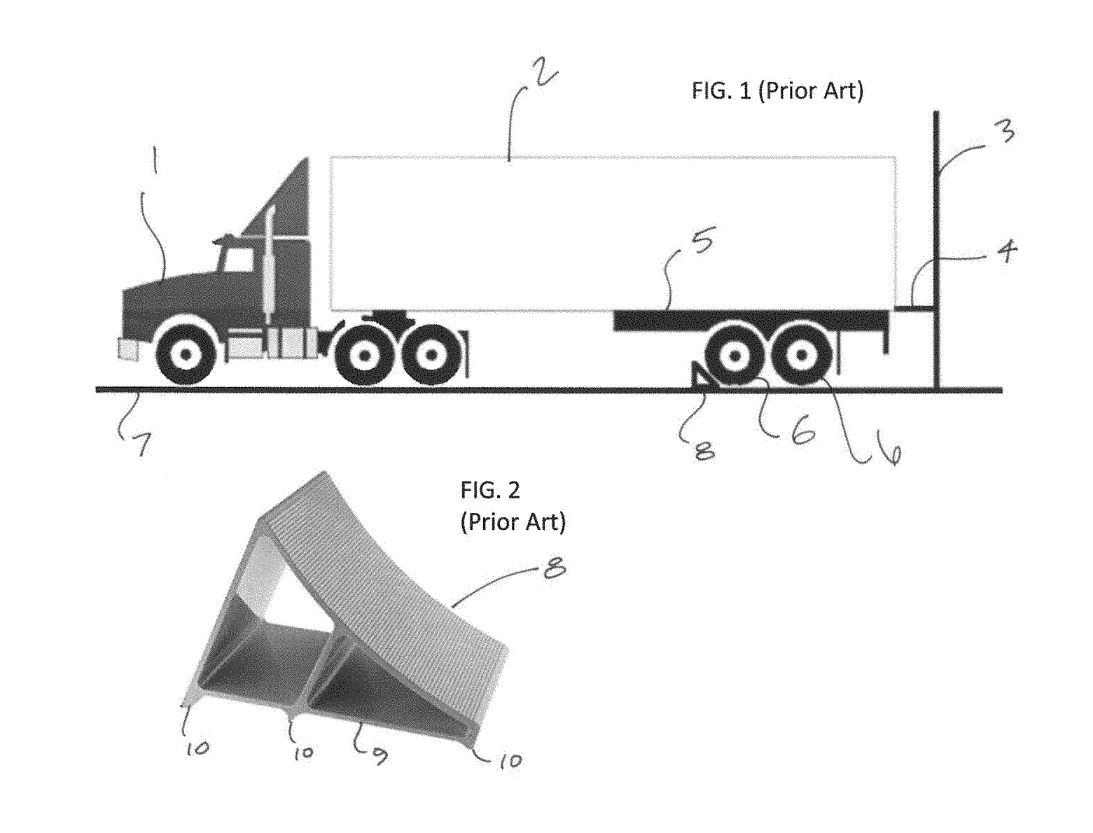

FIG. 1 shows an elevation view of a conventional prior art semi-transport combination with a truck tractor 1 with a trailer 2. The rear loading doors of the trailer 2 are backed up on the pavement 7 adjacent to the loading dock 3 and a dock leveler 4 (or dock bridge) is extended between the loading dock 3 and the trailer bed 5. The rear wheels 6 are restrained from moving forward in the example illustrated by manually placing a triangular wheel chock 8 in position on the front surface of the wheel 6. FIG. 2 is a perspective view of a conventional wheel chock of generally triangular shape made of extruded aluminum.

Conventional wheel chocks 8 are also made of solid rubber, wood or welded steel assemblies. As shown in FIG. 2, conventional wheel chocks 8 may include a base 9 with teeth 10 to grip into the pavement 7 and impede movement of the wheels 6 relative to the pavement 7. A wheel chock 8 can also be positioned between two tandem wheels 6 to prevent motion in the forward and rearward directions. Flags or protruding signs attached to the chock 8 are often used (but not shown) to indicate to the loading dock workers and the truck driver that the chocks 8 are in place.

Various other manual chocks, mechanically operated chocking mechanisms, or truck frame restraints are within the common general knowledge of those persons involved in operating loading docks and transport operations and need not be explained her in detail. It will be also understood that vehicle wheel restraint chocks are commonly used to prevent forward and rearward movement of all types of wheeled vehicles during loading, inspection or maintenance, for example railroad cars, forklift trucks, and aircraft. The wheel chock invention described herein can equally be used on both sides of a wheel to restrain any wheeled vehicle (ex: aircraft or rail car and is not limited to the transport truck example described herein.

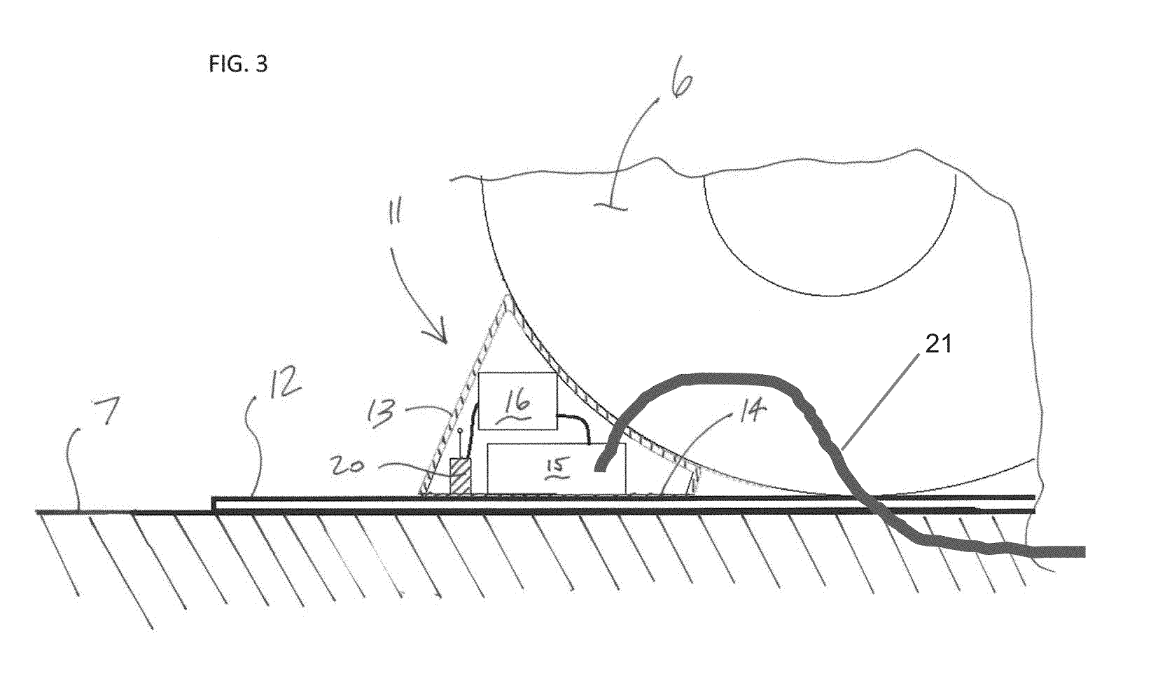

FIG. 3 a schematic view of a wheel 6 with an electrically powered electromagnetic wheel chock 11 in place to impede movement toward the left. A second electromagnetic wheel chock 11 could be placed to the right of the wheel 6 but is not shown. A steel plate 12 is anchored to the adjacent concrete or asphalt pavement 7 in the illustrated example. In the case of a railroad wheel (not shown) the steel railroad tracks are magnetically engaged by the electromagnetic chock 11.

The wedge shaped housing 13 of the electromagnetic wheel chock 11 has a base 14 adapted to engage the metallic wheel supporting surface of the steel plate 12. An electromagnet 15 is mounted to the housing 13 adjacent to the base 14. The electromagnet 15 is capable of being magnetically engaged and disengaged with the steel plate 12 (or railroad track). To lock and unlock the housing 13 to the steel plate 12 electrical power is provided by the battery 16. A radio transmitter/receiver can be housed within the chock housing 13 to remotely control the battery power supplied to the electromagnet 15. Alternatively the electromagnet 15, communications and sensor 20 can be hard wired with an electrical power cable 21 connecting to the power system of the loading dock 3 or the adjacent building. When the electrical power cable 21 is used, a battery 16 may still be included as an emergency power backup in case of power failure in the loading dock 3 or building. The electromagnet 15 can be remotely actuated from an operator control panel on the loading dock 3. The control panel can also display data from the sensor 20, battery charge status, and status of the electrical power supply available to the wheel chock 6.

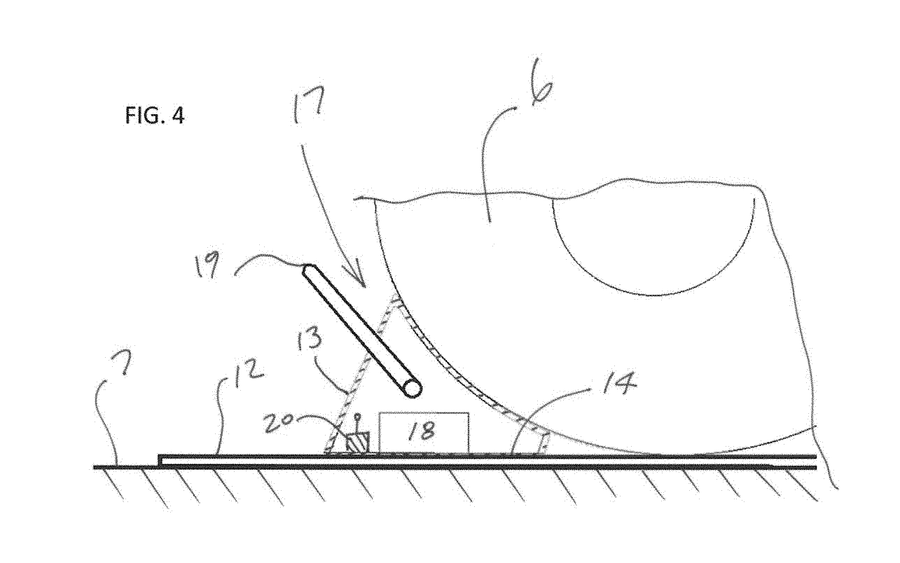

FIG. 4 is an alternative manually operated permanent magnet wheel chock 17 having an permanent magnet 18 operated with a manual lever 19 to engage and disengage the steel plate 12. For example, conventional permanent magnets and electromagnets are used in handling steel plates or steel components with cranes that can be manually or electrically engaged and disengaged by moving the permanent magnet towards and away from the steel plate. It is not considered necessary to describe such conventional permanent magnet systems in detail herein. Examples of manually operated permanent magnet lifting magnets are sold by the Eriez Manufacturing Company of Erie, Pa., under the trademark SAFEHOLD™. Examples of electrically powered electromagnets include electromagnet lifting magnets are sold by the Eriez Manufacturing Company and many low cost magnetic door locks manufactured by several companies and widely available wherever door hardware or locks are sold.

In the example illustrated in FIG. 4, the magnet 15 is a permanent magnet that is moved toward and away from the steel plate 10 with a mechanical manual lever 19 as an actuator. The lever 19 is rotatably mounted to the housing 13 and further serves as a visual indicator that the permanent magnet wheel chock 17 is in place and is engaged. For example, the up position of the lever 19 can indicate that the magnet 11 is engaged and a down position (not shown) can indicate that the permanent magnet 18 is disengaged from the steel plate 12. The permanent magnet wheel chock 11 can also include a proximity sensor 20 as described below.

In the electromagnetic wheel chock 11 of FIG. 3, an electrical power battery 16 can be mounted to the housing 13 or an electrical power wire 21 in communication with a source of electric power can be used to power the electromagnet 15 and a proximity sensor 20. The proximity sensor 20 is mounted to the housing 13 for sensing the presence and absence of the steel plate 12 or any other suitable magnetic metallic wheel supporting surface. In the event of electrical power failure in the wire 21, the battery 16 can provide emergency power to maintain operation of the electromagnet 15, sensor 20, communications and controls.

A control console (not shown) is located in the loading dock 3 is in wireless communication with the electromagnet 15 and/or the proximity sensor 20. The control console includes one of: an on/off signal transmitter for operating the electromagnet 15; a user interface indicator that the electromagnet 15 has magnetically engaged the metallic wheel supporting surface of the steel plate 12; a user interface indicator that the proximity sensor 20 has sensed the steel plate 12; and a user interface indicator that the proximity sensor 20 has failed to sense the steel plate 12.

A chock docking station (not shown) can be provided on the loading dock 3 remote from the wheel 6 to store the electromagnetic chock 11 when not in use and to recharge the battery 16 with a battery recharger.

In cold weather environments, the steel plate 12 can include electrically powered heaters to melt snow and ice, as well as a textured surface to improve traction. The steel plate 12 is easily mounted to the pavement 7 using countersunk head anchor bolts or can be embedded within the pavement 7.

Although the above description relates to a specific preferred embodiment as presently contemplated by the inventor, it will be understood that the invention in its broad aspect includes mechanical and functional equivalents of the elements described herein.

I claim:

1. A chock for use to restrain movement of a wheel relative to an underlying metallic wheel supporting surface, the chock comprising:
a wedge shaped housing with a base adapted to engage the metallic wheel supporting surface; and
a magnet mounted to the housing adjacent to the base, the magnet capable of being magnetically engaged and disengaged with the metallic wheel supporting surface to lock and unlock the housing.

2. The chock according to claim 1 wherein the magnet is a permanent magnet that is moved toward and away from the metallic wheel supporting surface with a mechanical actuator.

3. The chock according to claim 2 wherein the mechanical actuator is a lever rotatably mounted to the housing.

4. The chock according to claim 1 comprising an electrical power battery mounted to the housing and wherein the magnet is an electromagnet electrically powered by one of: a battery; and an electrical power wire in communication with a source of electric power.

5. The chock according to claim 1 comprising a steel plate anchored to a pavement surface supporting the wheel.

6. The chock according to claim 1 comprising a proximity sensor mounted to the housing for sensing the presence and absence of the metallic wheel supporting surface.

7. The chock according to any one of claims 4 and 6 comprising a control console in wireless communication with one of: the electromagnet; and the proximity sensor.

8. The chock according to claim 7 wherein the control console includes one of: an on/off signal transmitter for operating the electromagnet; a user interface indicator that the electromagnet has magnetically engaged the metallic wheel supporting surface; a user interface indicator that the proximity sensor has sensed the metallic wheel supporting surface; and a user interface indicator that the proximity sensor has failed to sense the metallic wheel supporting surface.

9. The chock according to claim 4 comprising a chock docking station remote from the wheel.

10. The chock according to claim 9 wherein the chock docking station a battery recharger.
